(19) United States
(12) Patent Application Publication
(10) Pub. No.: US 2024/0035169 A1
(43) Pub. Date: Feb. 1, 2024

(54) AN IMPROVED METHOD FOR OPERATION OF A SOLID OXIDE ELECTROLYSIS CELL IN CARBON DIOXIDE ELECTROLYSIS

(71) Applicant: TOPSOE A/S, Kgs. Lyngby (DK)

(72) Inventors: Rainer KÜNGAS, Peetri (EE); Thomas HEIREDAL-CLAUSEN, Birkerød (DK); Jeppe RASS-HANSEN, Copenhagen V (DK); Bengt Peter Gustav BLENNOW, Humlebæk (DK); Tobias Holt NØRBY, Glostrup (DK)

(73) Assignee: TOPSOE A/S, Kgs. Lyngby (DK)

(21) Appl. No.: 18/256,652

(22) PCT Filed: Dec. 14, 2021
(86) PCT No.: PCT/EP2021/085707

§ 371 Date: Jun. 9, 2023

(30) Foreign Application Priority Data
Dec. 22, 2020 (EP) 20216621.1

(51) Int. Cl. C25B 1/23; C25B 15/08; C25B 15/027

(52) U.S. Cl. CPC C25B 1/23; C25B 15/085; C25B 15/027

(57) ABSTRACT

The present invention regards a method for converting carbon dioxide into carbon monoxide in high-temperature, dry, solid oxide electrolysis providing increased lifetime of SOECs and SOEC stacks by addressing the problem of coking, while simultaneously ensuring highest possible CO production from each cell or stack.

### FIELD OF THE INVENTION

The present invention proposes an improved method for operating a solid oxide electrolysis cell (SOEC) in CO₂ (carbon dioxide) electrolysis. It also proposes an improved method for operating a solid oxide electrolysis cell (SOEC) stack in CO₂ (carbon dioxide) electrolysis.

### BACKGROUND OF THE INVENTION

Electrolysis cells can be used to electrochemically convert H₂O (water) to H₂ (hydrogen), CO₂ to CO (carbon monoxide) or a combination of H₂O and CO₂ to synthesis gas (combinations of CO, CO₂, H₂ and H₂O). Carbon monoxide is traditionally produced from fossil fuels, for example via steam reforming of natural gas. The production of CO using traditional methods is therefore associated with significant CO₂ emissions. Alternatively, carbon monoxide can be produced via electrolysis of CO₂. If electricity from low-carbon energy sources (wind, solar, nuclear etc.) are used for the electrolysis process, the CO₂ emissions associated with CO production can be minimized, or even be negative. Electrolysis is thus a potentially more sustainable method for producing CO compared to traditional fossil fuel-based methods.

The methods for CO₂ electrolysis can in general be classified into two groups: low-temperature CO₂ electrolysis and high-temperature CO₂ electrolysis. Low-temperature CO₂ electrolysis, often referred to as electrochemical CO₂ reduction (eCO₂R), is a process where a carbon dioxide reduction reaction (CO₂+H₂O+2 e⁻→CO+2 OH⁻) is carried out in aqueous solutions on the cathode of the cell and the water molecule is involved in the electrochemical reaction, being converted from H₂O into OH⁻ on the cathode. It may be referred to as “wet electrolysis”. At atmospheric pressure, the operation temperature of low-temperature CO₂ electrolysis cells is limited to 100° C. due to the reaction fluid mainly being water. In low-temperature electrolysis, the diffusion coefficient for CO₂ is relatively low and the overpotential applied is high. The electrolyte is generally polymeric or even liquid since it does not need to resist high temperatures. Examples of products obtainable by low-temperature electrolysis are hydrogen gas, carbon monoxide, methanol, ethylene and formic acid. The main challenges in low-temperature, wet CO₂ electrolysis include electrode instability, poor selectivity towards CO production, high electric power consumption, and low current density. An example of low temperature electrolysis may be found in e.g. WO18228723.

High-temperature CO₂ electrolysis refers to CO₂ electrolysis in Solid Oxide Electrolysis Cells (SOECs). In SOEC, the carbon dioxide reduction reaction (CO₂+2 e⁻→CO+O²⁻) is carried out in gas phase on the surface of a suitable catalyst. The typical operating temperature of SOECs is between approximately 600° C. and 1000° C. In high-temperature electrolysis, the diffusion coefficient for CO₂ is relatively high and the overpotential applied is low. The electrolyte is generally made of ceramic materials, such as stabilized zirconia or doped ceria, which become oxygen-ion conductors at high temperatures.

High-temperature electrolysis may be carried out with or without the presence of steam. When steam is present, it may be referred to as “wet electrolysis”. An example of a product obtainable by high-temperature wet electrolysis is synthesis gas (combinations of CO, CO₂, H₂ and H₂O). An example of high-temperature wet electrolysis may be found in e.g. WO18206235. When steam is not present, it may be referred to as “dry electrolysis”. An example of a product obtainable by high-temperature, dry electrolysis is carbon monoxide gas, and in particular a high purity carbon monoxide gas (essentially combinations of CO and CO₂). Examples of high-temperature dry electrolysis may be found in e.g. WO 2018/228716, WO 2016/091636, WO 2015/014527, WO 2014/154253, WO 2018/206235.

In particular, WO 2018/206235 discloses in its example 1 an operating point for dry electrolysis in an SOEC stack consisting of 75 cells. It is operated at an average temperature of 700° C. with pure CO₂ fed to the cathode at a flow rate of 100 Nl/min, while applying an electrolysis current of 50 A. The gas exiting the cathode side of the stack consists of 26% CO and 74% CO₂.

An SOEC for high-temperature electrolysis generally includes a fuel electrode, a solid electrolyte, an oxy electrode, and optionally contact layers to increase in-plane electrical conductivity and provide improved contact to adjacent interconnects. In the context of this invention, the term “fuel side” refers to the side of the SOEC that comprises the fuel electrode and where the CO₂ reduction reaction (CO₂+2 e⁻→CO+O²⁻) is occurring. The term “oxy side” refers to the side of the SOEC that comprises the oxy electrode and where the O₂ evolution reaction (2O²⁻→O₂+4 e⁻) is occurring. The SOEC may be arranged in a stack of cells (designated an SOEC stack). In an SOEC stack a plurality of cells are generally electrically connected in series and fluidly connected in parallel. The cells are generally arranged in a spaced apart position by interposing interconnection plates (also referred to as interconnects). The interconnection plates serve to provide electrical contact between adjacent cells and flow fields for fuel and oxygen to the fuel and oxygen electrodes, respectively. In a CO₂ electrolysis system, a plurality of SOEC stacks are normally operated simultaneously to reach the required CO production rate. In a system for high-temperature CO₂ electrolysis, the stacks are generally arranged to be fluidly connected in parallel, and preferably they are arranged around an inlet manifold for simultaneously providing the fuel gas to each of the SOEC stacks.

### SUMMARY OF THE INVENTION

It is generally desirable to reduce the operating expenditure (OPEX) and the capital expenditure (CAPEX) of a CO₂ electrolysis system. Intuitively, the OPEX can be minimized by operating the SOEC stacks at the maximum possible conversion. In dry CO₂ electrolysis this means converting the highest possible amount of CO₂ feed into carbon monoxide (CO) product. The maximum possible CO₂ conversion is determined by thermodynamics, and it is a function of the CO/CO₂ ratio in the gas, the absolute pressure and the temperature. For example, at 800° C. in dry CO₂ electrolysis at 1 bar, the maximum CO/CO₂ ratio is about 11.8. At higher CO/CO₂ ratios, higher pressures and lower temperatures, the Boudouard reaction (2 CO═CO₂+C) becomes thermodynamically favorable. The Boudouard reaction leads to carbon formation (also referred to as coking or carbonisation) in the cell, which in turn can lead to cell and stack failure. As a result, the task of operating an SOEC stack becomes more complex.

On one hand, it is desirable to maximize the CO₂ conversion and operate at very high CO/CO₂ ratios in the product stream/at stack outlet to minimize the OPEX, but such operation strategy can lead to cell failure and expensive stack replacements due to coking. On the other hand, if the stack is operated at very low CO₂ conversions, then it is not utilized optimally and more stacks will be needed to reach a desired CO production rate.

We have found that one of the main challenges in high-temperature CO₂ electrolysis includes coking (carbon formation).

The aim of this invention is to increase the lifetime of SOECs and SOEC stacks by addressing the problem of coking, while simultaneously ensuring highest possible CO production from each cell or stack.

Chemical processes involving the presence of CO and CO₂ have a tendency to carbonize (to coke). It is known that the probability of coking (the formation of carbon, C) in a CO/CO₂ system is determined by the thermodynamics of the Boudouard reaction (2 CO— CO₂+C). Thermodynamics determines the tendency of the reaction to take place, while kinetics determine the rate of the reaction. It is thus known that in CO—CO₂ gas mixtures the probability of coking (the formation of C from CO) increases at higher CO/CO₂ ratios, higher pressures and lower temperatures. For example, in a dry CO/CO₂ mixture at 800° C. and atmospheric pressure, coking is thermodynamically favored whenever the CO/CO₂ ratio is above 7.8. At 750° C., coking is thermodynamically favored when the CO/CO₂ ratio is above 3.6, while at 700° C., coking is thermodynamically favored when the CO/CO₂ ratio is above 1.7.

It is thus also known from the Boudouard reaction that for a given dry CO/CO₂ system with a specific CO/CO₂ ratio, a critical temperature can be determined, below which the tendency of CO to carbonize is greatly increased. This temperature may be referred to as the Boudouard temperature. Based on the values listed above, the Boudouard temperature for a CO—CO₂ system with a CO/CO₂ ratio of 7.8 is 800° C., the Boudouard temperature for a CO—CO₂ system with a CO/CO₂ ratio of 3.6 is 750° C., and the Boudouard temperature for a CO—CO₂ system with a CO/CO₂ ratio of 1.7 is 700° C.

Therefore, the inventors believed that if an SOEC was operated above the Boudouard temperature, then coking problems could be avoided inside the SOEC. However, the inventors have now found that even when an SOEC was operated above the Boudouard temperature, it was still prone to coking, thus adversely affecting the lifetime. The inventors also found, that there was no clear pattern as to when coking could be avoided and when coking took place when operating above the Boudouard temperature.

The inventors have now found that in an SOEC, the probability of coking is not only determined by the combination of the operating temperature and the CO/CO₂ ratio exiting the cell or stack, but that the conditions in an SOEC under which coking is much more prone to occur mainly depend on a combination of the following critical parameters: inlet temperature (T), space velocity (SV_{fuel}) and CO concentration (X_{CO}) of the fuel gas; inlet temperature (T) and space velocity (SV_{flush}) of the flush gas; and electrolysis current density (i) across the electrolyte in SOEC.

In a first aspect, the invention regards a method for converting carbon dioxide into carbon monoxide in high-temperature, dry, solid oxide electrolysis, the method comprising the following steps:
1) providing a fuel gas stream comprising 70-100 vol % CO₂, 0-30 vol % CO, wherein the molar fraction of CO (x_{CO}) is in the range of from 0 to 0.3;
2) providing a flush gas stream;
3) providing a solid oxide electrolysis cell (SOEC) having a fuel side and an oxy side;
4) heating the fuel gas stream and the flush gas stream to a gas stream inlet temperature, T, in the range of from 600 to 1000° C., such as from 700° C. to 850° C.;
5) supplying the fuel gas stream to the fuel side of the SOEC at a space velocity, SV_{fuel}, in the range of from 2 to 30 s⁻¹;
6) supplying the flush gas stream to the oxy side of the SOEC at a space velocity, SV_{flush} in the range of from 0.1 to 20 s⁻¹;
7) applying an electrolysis current with a current density, i, in the range of from −0.2 A/cm² to −1 A/cm² across the solid electrolyte to electrolytically convert a fraction of the CO₂ into CO on the fuel side of the SOEC and to produce an O₂ enriched flush gas on the oxy side of the SOEC.

This process results in high conversion of CO₂ in the cell without compromising the lifetime of the SOEC.

The inventors found that adjusting the relation between a combination of five process parameters: inlet temperature, space velocity of the fuel gas, CO concentration of the fuel gas, space velocity of the flush gas, and electrolysis current density across the SOEC provided conditions which would avoid or greatly reduce the coking in the SOEC.

For production of CO-enriched gases on an industrial scale, the SOECs will normally be arranged into SOEC stacks. Multiple stacks may further be arranged into SOEC systems.

In dry, solid oxide electrolysis, the fuel gas stream should be dry, which means that the fuel gas stream comprises only around 0-1 vol % H₂O. This is to avoid the reaction of water with carbon monoxide to form hydrogen and carbon dioxide (water-gas shift reaction). It is much more difficult to separate CO from a mixture of CO₂, CO, H₂O and H₂ than from a mixture of CO and CO₂ (see e.g. WO18228716). In addition, it is preferred that the fuel gas stream comprises only around 0-1 vol % H₂. This is to avoid the reaction of hydrogen with carbon dioxide to form water and carbon monoxide (reverse water gas shift). It is more difficult to separate CO from a mixture of CO₂, CO, H₂O and H₂ than from a mixture of CO and CO₂. The fuel gas may comprise other non-reactive components in small amounts.

It is generally preferred that the temperature is kept fairly uniform within the cells, between the cells (i.e. within the stack) and between the stacks (i.e. within the system for high-temperature CO₂ electrolysis). In practice, however, there may be small temperature gradients both between cells and within the cell. For example, the temperature variation within the cell may be 25, 30, 40 or even 50° C. In particular, the difference between inlet temperature and outlet temperature may be up to 50° C., or even up to 75 or 100° C. without departing from the invention. The inlet temperature of the fuel gas stream and the flush gas stream may also vary. In case the flush gas and the fuel gas have different inlet temperatures or in case the inlet temperature varies across different inlets, the average inlet temperature (i.e. arithmetic mean of inlet temperatures) should be used for T. This is so for all aspects of the invention.

It is to be understood that in an SOEC the fuel side and the oxy side must be in ionic contact through a solid electrolyte in order to be operational.

In a second aspect of the invention, a method is provided for selecting the operating conditions for high-temperature, dry CO₂ electrolysis in a solid oxide electrolysis cell (SOEC) having a fuel side and an oxy side in ionic contact through a solid electrolyte, the method comprising the steps of:
i. supplying a fuel gas stream at a space velocity, SV_{fuel} in the range of from 2 to 30 s⁻², where the fuel gas stream comprises 70-100 vol % CO₂ and 0-30 vol % CO, wherein the molar fraction of CO (x_{CO}) is in the range of from 0 to 0.3 to the fuel side of the SOEC;
ii. supplying a flush gas stream at a space velocity, SV_{flush}, to the oxy side of the SOEC in the range of from 0.1 to 20 s⁻¹
iii. supplying heat to the SOEC by heating the fuel and flush gas streams to a gas stream inlet temperature T, in the range of from 600 to 1000° C. and then
iv. applying an electrolysis current i across the electrolyte of the SOEC at a current density in the range of from −0.2 A/cm² to −1 A/cm²,
wherein the values for T, SV_{fuel}, SV_{flush} and i are selected by an iterative process as follows:
a) setting the operating conditions for T, SV_{fuel} SV_{flush}, and i to initial values;
b) determining local temperatures and local gas compositions for a number of diversely distributed locations in the cell;
c) on the basis of the local gas compositions, estimating the local temperatures below which carbon formation via the Boudouard reaction is thermodynamically favorable (the local Boudouard temperature) for each of the locations,
d) subtracting the local Boudouard temperature from the measured local temperature thereby obtaining the Boudouard margin, and
e) varying the gas flow rates, inlet temperature(s) and/or electrolysis current density until the Boudouard margin is larger than zero for each of the locations.

This method for selecting the operating conditions for high-temperature, dry CO2 electrolysis in a solid oxide electrolysis cell may be used as a trial-and-error procedure to obtain a set of operating parameters for a given SEOC or SOEC stack, which in combination will provide a method for converting carbon dioxide into carbon monoxide in high-temperature, dry, solid oxide electrolysis, which is outside the Boudouard temperature area, meaning that no significant coking will happen.

### FIGURE

FIG. 1 is a schematic view of an SOEC.

FIG. 2 is a block diagram showing an embodiment of a system comprising the SOEC.

FIGS. 3a and 3b are schematic views of an SOEC stack repeating unit.

FIGS. 4a, 4b, 4c, 4d and 4e depict the relation between coking potential (CP) and the various critical process parameters (T, SV_{flush}, SV_{fuel}, % CO, and i), demonstrating the effect of each parameter under otherwise fixed conditions.

FIG. 5 shows exemplary coking potentials as calculated by Formula (I) for a number of possible SV_{fuel}, SV_{flush} and i combinations, based on assumptions regarding V_{fuel}, V_{oxygen}, and cell active area. In Case #1, V_{fuel} V_{oxygen} and cell active area (A) values have been taken from Example 1 of current application.

### DETAILED DESCRIPTION OF THE INVENTION

Disclosed herein is a method for converting carbon dioxide into carbon monoxide in high-temperature, dry, solid oxide electrolysis as defined above.

In the present context the term “inlet temperature” is intended to refer to the temperature in the vicinity of the location(s) where gases enter the cell or stack, for example in a gas manifold underneath the cell or stack. Experimentally, inlet temperature is easily determined with the help of a thermocouple. In case the flush gas and the fuel gas have different inlet temperatures or in case the inlet temperature varies across different inlets, the average inlet temperature (i.e. arithmetic mean of inlet temperatures) should preferably be used.

The term “flush gas” is intended to refer to the gas that is fed to the oxy-side of the SOEC cell or stack. Flush gas is used to transport oxygen, formed in the anode reaction, out of the cell or stack. Flush gas flow can further be used to level out temperature gradients in the cell or stack.

The term “fuel gas” is intended to refer to the gas fed to the fuel-side of the SOEC cell or stack. In the present context, where the SOEC is operated in dry CO₂ electrolysis mode (i.e. converting CO₂ into CO and O₂), fuel gas comprises CO₂ and optionally CO. It may additionally comprise traces of other components such as H₂, N₂, H₂O up to a total amount of less than 5%.

The term “product gas” is intended to refer to the gas that exits the fuel-side of the SOEC cell or stack. In the present context, where the SOEC is operated in dry CO₂ electrolysis, product gas comprises CO and CO₂. As long as an electric current is running through the SOEC cell or stack, the CO-content in the product gas will be higher than the CO-content in the fuel gas. The product gas may additionally comprise traces of other components such as H₂, N₂, H₂O up to a total amount of less than 5%.

“Space velocity” is a widely used parameter for describing the rate of gas flow through a reactor, such as an SOEC or an SOEC stack. Space velocity, SV, is as used herein defined as the number of reactor volumes of feed passing through the reactor per unit time. Accordingly, “space velocity of flush gas” refers to the volumetric flow rate of flush gas, divided by the total volume of the oxy side compartment of the SOEC cell or stack and “space velocity of fuel gas” refers to the volumetric flow rate of fuel gas, divided by the total volume of the fuel side compartment of the SOEC cell or stack. The volumetric flow rate of gases is easily determined using gas flow meters or rotameters and the values as given herein refer to values measured under normal conditions (0° C., 1 atm). The total volume of the fuel-side (cathode) and oxy-side (anode) compartments of an SOEC cell or stack can be determined from technical drawings. Alternatively, the total volume of the fuel compartment (V_{fuel}) in an SOEC stack can be estimated according to the following equation:

V_{fuel}=W·L·H_{fuel,av}·n

where W is the width of the SOEC active area, L is the length of the SOEC active area, H_{fuel,av} the average height of a fuel-side gas channel and n the number of gas channels in a stack. In case a single SOEC is tested, then n is equal to 1. Analogously, the total volume of the oxy side of the SOEC (V_{oxygen}) can be determined according to the following equation:

V_{oxygen}=W·L·H_{oxygen,av}·n

where H_{oxygen,av} is the average height of an oxy-side gas channel. W, L, H_{fuel,av}, and H_{oxygen,av} can be measured or calculated using geometric equations.

The term “molar fraction” (x_{CO}) of a gas species in a gas refers in the present context to the number of moles of a gas species in a gas mixture, divided by the total number of moles in the gas mixture. For example, when the molar fraction of CO in the fuel gas is 5 mol %, then x_{CO}=0.05. The term “electrolysis current density” is defined as the total electrolysis current running through the cell or stack, divided by the SOEC active area. “SOEC active area” refers to the geometric area of the SOEC that is electrochemically active, i.e. that participates in the electrochemical reactions. For an SOEC with a rectangular active area, the active area can be estimated by multiplying W with L.

In the context of the invention, the term “inert” refers to a gas species that does not participate in chemical or electrochemical reactions in the SOEC at the relevant temperatures. Inert species typically include nitrogen, argon, helium, etc. Under some circumstances, for example when the inert gas is used as a flush gas, the inert gases can also include CO₂, air, steam, etc.

In the present context “local” is meant to refer to a volume that is smaller than 12×12×12 cm³, preferably smaller than 1×1×1 cm³ and more preferably smaller than 0.1×0.1×0.1 cm³.

The typical operating temperature of SOECs is between approximately 600° C. and 1000° C.: high temperatures are required in order to reach sufficient oxide ion conductivities in the ceramic membranes that are used as electrolytes. Commonly used electrolyte materials include stabilized zirconias, such as yttria-stabilized zirconia (YSZ), doped cerias, doped lanthanum gallates, and others. Commonly used oxy-electrode materials include perovskite materials, such as Sr-doped LaMnO₃ (LSM), Sr-doped LaFeO₃ (LSF), Sr-doped LaCoO₃ (LSC), Sr-doped La(Co,Fe)O₃ (LSCF), Sr-doped SmCoO₃ and many others. Perovskite materials are further commonly mixed with doped cerias to form composite oxy electrodes (SOEC anodes). Dopants other than Sr, e.g. Ca, Ba are known, as are materials other than perovskites, e.g. Ruddlesden-Popper phases. Commonly used fuel electrode materials include composites of metallic Ni and stabilized zirconia, e.g. Ni-YSZ, or metallic Ni and doped ceria.

The inventors have now found an operating window for SOEC stacks in CO₂ electrolysis, which allows for safe operation of SOEC stacks at the highest possible CO/CO₂ ratios. In particular, the present inventors have defined a coking potential (CP) for a stack, and they further found that the coking potential (CP) may be estimated as a function of T, SV_{flush}, SV_{fuel}, x_{CO}, and i, and is defined by:

CP=−351.3+1.3828*T+10.249*SV_{flush}−15.570*SV_{fuel}+845*x_{CO}+103.67*i−0.001210*T²+1.2418*SV_{fuel}²−6677*x_{CO}²−68.38*i²−0.017976*T*SV_{flush}−0.017249*T*SV_{fuel}+0.1987*T*x_{CO}−0.54114*T*i+0.04299*SV_{flush}*SV_{fuel}+0.884*SV_{flush}*x_{CO}−2.4723*SV_{flush}*i+10.11*SV_{fuel}*x_{CO}+11.021*SV_{fuel}*i+51.0*x_{co}*i (I)

In an embodiment, the SOEC or SOEC stack is operated under conditions where CP≤−50. This provides for high conversion of CO₂ into CO and a long lifetime of the SOEC exceeding one year.

Simultaneously, economic profitability is maximized when the SOEC stack is operated such that CP≤−15. This provides for high conversion of CO₂ into CO and a long lifetime of the SOEC exceeding one year and at the same time high profitability. In an embodiment of the invention, The CP is in the range of from −75 to −15. There is not an actual lower range for CP. However, lower ranges of CP cold be −100, −80, or −75. Formula (I) was empirically determined at atmospheric pressure. Accordingly, the empirical formula (I) is applicable at pressures near atmospheric pressure, at least at absolute pressures of 0.5 to 2 bar, such as of 0.7 to 1.8 bar.

In an embodiment, the fuel gas stream comprises 80-100, such as 88-98, vol % CO₂. In an embodiment, the fuel gas stream comprises 0-20 vol %, such as 1-12 vol %, CO. In an embodiment, the fuel gas stream comprises 80-100, such as 88-98, vol % CO₂ and 0-20 vol %, such as 1-12 vol %, CO. In an embodiment, the molar fraction of CO (x_{co}) of the fuel gas stream is in the range of from 0 to 0.2, such as from 0.01 to 0.15 or 0.05 to 0.1. In an embodiment, the product gas stream comprises in the range of from 15-95 vol % CO, such as from 15-90, 20-80, 20-70, 20-60, 20 to 50 vol % CO, or from 30 to 50 vol % CO. In an embodiment, any remainder of gases present in the fuel gas stream are inert gases (e.g. N₂ or noble gases).

In a particular embodiment, the fuel gas stream consists of vol % CO₂, 0-20 vol % CO, 0-1 vol % H₂O and 0-1 vol % H₂, the remainder being inert, wherein the molar fraction of CO (x_{co}) is in the range of from 0 to 0.2, such as from 0.01 to 0.15 or 0.05 to 0.1. Such a fuel gas stream has the advantage that a product gas stream may be obtained, which comprises in the range of from 20 to 50 vol % CO and a low content of H₂O and H₂.

In another particular embodiment, the fuel gas stream consists of 88-98 vol % CO₂, 1-12 vol % CO, 0-1 vol % H₂O and vol % He r the remainder being inert, wherein the molar fraction of CO (x_{co}) is in the range of from 0 to 0.2. Such a fuel gas stream has the advantage that a product gas stream may be obtained, which comprises in the range of from 20 to 50 vol % CO and a low content of H₂O and H₂.

In another embodiment, a method for selecting the operating conditions for a certain SOEC stack design is initiated by selecting an initial set of T, SV_{fuel}, SV_{flush}, X_{co} and i using formula (I) fulfilling CP=_15 then proceeding according to the guidance for selecting operating parameters as claimed in claim 15.

### DETAILED DESCRIPTION OF THE FIGURES

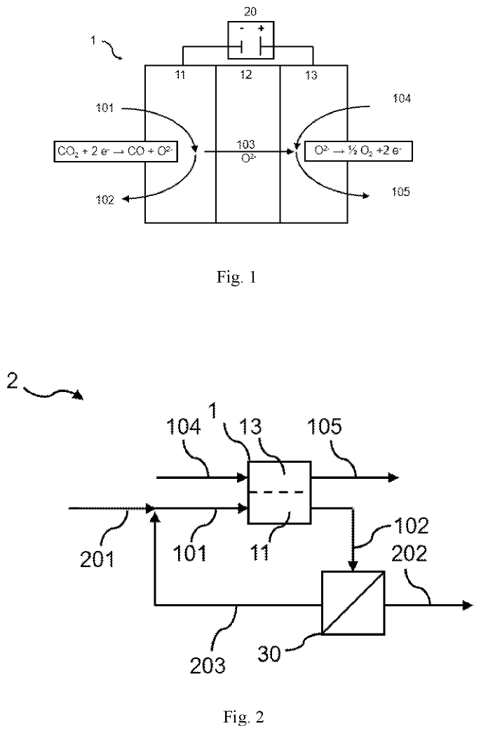

FIG. 1 is a schematic view of an SOEC. The SOEC (1) comprises a fuel side (11), an oxygen-ion conducting electrolyte (12) and an oxy side (13). Fuel gas (101) is fed to the fuel side (11), where a fraction of the CO2 present in the gas stream is electrochemically converted into CO. The driving force for the electrochemical reaction is provided by the electric potential that is supplied by the power supply unit (20). The resulting product gas stream (102) has a higher CO content than the fuel gas (i.e. is enriched in CO) this CO enriched product gas stream is collected from the fuel side of the SOEC. A current of oxygen ions passes through the electrolyte and (103) onto the oxy side of the SOEC (13). On the oxy-side of the SOEC, an anode reaction takes place to oxidise the ionic oxygen. Flush gas (104) is used to transport oxygen, formed in the anode reaction, out of the SOEC. As a result of the electrochemical reaction on the oxy side, the flush gas stream (104) becomes enriched in oxygen. The oxygen enriched flush gas stream (105) is collected from the oxy-side of the SOEC.

FIG. 2 is a block diagram showing an embodiment of a system comprising the SOEC (2). A gas stream (201) is optionally mixed with a CO₂ enriched gas stream (203) and the resulting fuel gas stream (101) is fed onto the fuel-side (11) of the SOEC (10). A fraction of the CO₂ present in the fuel gas stream is electrochemically converted into CO. The resulting CO enriched product gas stream (102) stream is collected from the fuel side of the SOEC. The product gas stream (102) can optionally be fed to a gas purification unit (30), where the product gas stream (102) is divided into a first, CO enriched product gas stream (202) and a second, CO₂ enriched product gas stream (203). The CO2 enriched product gas stream (203) can optionally be recycled back to the fuel side of the SOEC, as described above.

A flush gas stream (104) is fed to the oxy-side (13) of the SOEC (10). As a result of the electrochemical reaction on the oxy side, the flush gas stream (104) becomes enriched in oxygen. The oxygen enriched flush gas stream (105) is collected from the oxy-side of the SOEC.

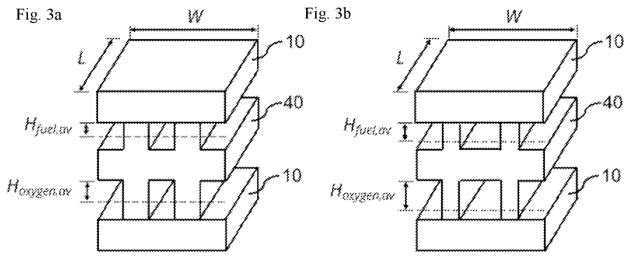

FIG. 3 is a schematic view of an SOEC stack repeating unit. More specifically, it is shown how an interconnect (40) is located between adjacent SOECs (10). In the figure, the oxy-side of the SOEC is facing upwards, while the fuel-side of the SOEC is facing downwards. The width of the SOEC, W, and the length of the SOEC, L, are schematically shown. Two different, arbitrary interconnect geometries are shown. In FIG. 3a, the average height of the fuel-side gas channel H_{fuel,av} and the average height of the oxy-side gas channel H_{oxygen,av} are lower than in FIG. 3b due to the geometrical differences between the interconnect designs in the two figures.

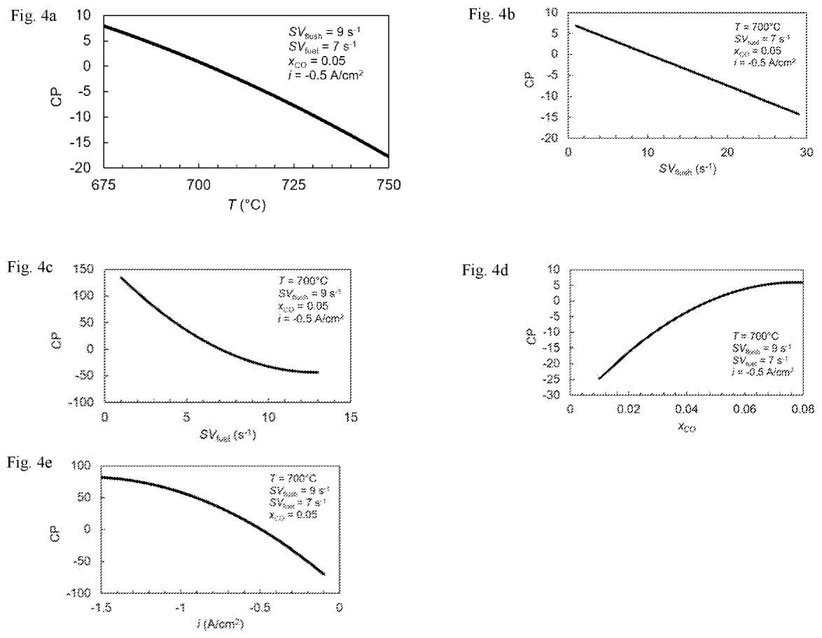

FIGS. 4a, 4b, 4c, 4d and 4e depict the relation between coking potential (CP) and each of the various critical process parameters (T, SV_{flush}, SV_{fuel}, % CO, and i), demonstrating the effect of each parameter under otherwise fixed conditions. FIG. 4 is explained in more detail in Examples 4-8.

The method is illustrated in more detail in the non-limiting examples which follow.

### EXAMPLES

### Example 1

An SOEC stack was operated in dry CO₂ electrolysis under conditions where coking was not expected based on thermodynamic considerations, but where the coking potential was positive.

More specifically, a fuel gas (food-grade CO₂) was heated using electric heaters, thereby increasing the inlet temperature (T) to 725° C. The fuel gas composition was ≥99.9% CO₂ and the CO-content was on ppm-level (i.e. x_{CO}=0). The SOEC stack comprised 75 cells connected in series, each with an active area of 108 cm². The total volume of the fuel-side compartment (V_{fuel}) was 243 cm³, while the total volume of the oxy-side compartment (V_{oxygen}) was 405 cm³. Fuel gas was fed to the stack at a volumetric flow rate of 1.1 Nm³/h, corresponding to a space velocity of fuel gas (SV_{fuel}) of 1.26 s⁻ⁱ. Air was used as flush gas on the oxy-side of the stack and was fed to the stack at a volumetric flow rate of 1.5 Nm³/h, corresponding to a space velocity of the flush gas (SV_{flush}) of 1.03 s⁻¹. Stack current was fixed at −40 A, corresponding to an electrolysis current density (i) of −0.37 A/cm². Under these conditions, 60% of the CO₂ that was fed to the stack was converted into CO, corresponding to a CO/CO₂ ratio of 60/40=1.5 near stack outlet.

In a dry CO/CO₂ mixture at 725° C., coking is thermodynamically favored whenever the CO/CO₂ ratio is above 2.47, corresponding to a CO₂ conversion of 71.2%. In other words, based on thermodynamic considerations, no carbon should have formed inside the stack. However, the stack suffered from substantial coking, failing after only 12.5 hours of operation.

The coking potential (CP) under the above conditions is 72.3, i.e. coking is in fact strongly favored in the stack, thereby explaining why the stack failed after just a few hours of testing. Carbon formation in the stack was also confirmed in a post-test analysis using Raman spectroscopy.

### Example 2

An SOEC stack was operated in dry CO₂ electrolysis under conditions where coking was not expected based on thermodynamic considerations, and where the coking potential was negative, i.e. according to the method of the invention.

More specifically, a fuel gas (food-grade CO₂) was heated using electric heaters, thereby increasing the inlet temperature (T) to 750° C. The fuel gas was a mixture of food-grade CO₂ and CO. The CO-content in the fuel gas was on 3.6% (i.e. x_{CO}=0.036). The SOEC stack comprised 75 cells connected in series, each with an active area of 108 cm². The total volume of the fuel-side compartment (V_{fuel}) was 243 cm³, while the total volume of the oxy-side compartment (V_{oxygen}) was 405 cm³. Fuel gas was fed to the stack at a volumetric flow rate of 8 Nm³/h, corresponding to a space velocity of fuel gas (SV_{fuel}) of 9.14 s⁻¹. A mixture of air and CO₂ was used as flush gas on the oxy-side of the stack and was fed to the stack at a volumetric flow rate of 14.3 Nm³/h, corresponding to a space velocity of the flush gas (SV_{flush}) of 9.81 s⁻¹. Stack current was fixed at −50 A, corresponding to an electrolysis current density (i) of −0.46 A/cm². Under these conditions, 19.6% of the CO₂ that was fed to the stack was converted into CO, corresponding to a CO/CO₂ ratio of (19.6+3.6)/(100−19.6−3.6)=0.30 near stack outlet.

In a dry CO/CO₂ mixture at 750° C., coking is thermodynamically favored whenever the CO/CO₂ ratio is above 3.6, corresponding to a CO₂ conversion of 78.4%. In other words, based on thermodynamic considerations, no carbon should form inside the stack under operation. The coking potential (CP) under the above conditions is −59.9, i.e. coking does not occur.

### Example 3

An SOEC stack was operated in dry CO₂ electrolysis under conditions where coking was not expected based on thermodynamic considerations, and where the coking potential was negative, i.e. according to the method of the invention.

More specifically, a fuel gas (food-grade CO₂) was heated using electric heaters, thereby increasing the inlet temperature (T) to 745° C. The fuel gas was a mixture of food-grade CO₂ and CO. The CO-content in the fuel gas was on 3.6% (i.e. x_{CO}=0.036). The SOEC stack comprised 75 cells connected in series, each with an active area of 108 cm². The total volume of the fuel-side compartment (V_{fuel}) was 243 cm³, while the total volume of the oxy-side compartment (V_{oxygen}) was 405 cm³. Fuel gas was fed to the stack at a volumetric flow rate of 8 Nm³/h, corresponding to a space velocity of fuel gas (SV_{fuel}) of 9.14 s⁻¹. A mixture of air and CO₂ was used as flush gas on the oxy-side of the stack and was fed to the stack at a volumetric flow rate of 14.3 Nm³/h, corresponding to a space velocity of the flush gas (SV_{flush}) of 9.81 s⁻¹. Stack current was fixed at −70 A, corresponding to an electrolysis current density (i) of −0.65 A/cm². Under these conditions, 27.4% of the CO₂ that was fed to the stack was converted into CO, corresponding to a CO/CO₂ ratio of (27.4+3.6)/(100−27.4−3.6)=0.45 near stack outlet.

In a dry CO/CO₂ mixture at 745° C., coking is thermodynamically favored whenever the CO/CO₂ ratio is above 3.37, corresponding to a CO₂ conversion of 77.1%. In other words, based on thermodynamic considerations, no carbon should form inside the stack under operation. The coking potential (CP) under the above conditions is −30.5, i.e. coking does not occur. Two stacks were operated under the above conditions for more than a year without coking. From an economic perspective, operation under conditions listed in Example 3 are more lucrative than operation under conditions listed in Example 2, since more CO gas can be produced per stack per hour.

### Example 4

The coking potential (CP) is estimated for a set of realistic operating conditions. The space velocity of the flush gas is fixed at SV_{flush}=9 s⁻¹, the space velocity of the fuel gas is fixed at SV_{fuel}=7 s⁻¹, the molar fraction of CO in the fuel gas was x_{CO}=0.05, and the electrolysis current density was fixed at i=−0.5 A/cm². The effect of varying the inlet temperature (T) was investigated and is plotted in FIG. 4a. Under the chosen set of operating conditions, CP=7.9 at 675° C., CP=0 at 703° C., and CP=−17.9 at 750° C. Generally, the higher the inlet temperature, the lower the CP. Therefore, in order to avoid carbon formation, it desirable to operate the stack at high temperature, provided this does not compromise stack lifetime via other mechanisms (e.g. interconnect corrosion).

### Example 5

CP is estimated for a set of realistic operating conditions: The inlet temperature is fixed at T=700° C., the space velocity of the fuel gas is fixed at SV_{fuel}=7 s⁻¹, the molar fraction of CO in the fuel gas was x_{CO}=0.05, and the electrolysis current density was fixed at i=−0.5 A/cm². The effect of varying the space velocity of the flush gas (SV_{flush}) was investigated and is plotted in FIG. 4b. Under the chosen set of operating conditions, CP=6.9 at 1 s⁻¹, CP=0.8 at 9 s⁻¹, and CP=−14.2 at 29 s⁻¹. Generally, the higher the space velocity of the flush gas, the lower the CP. Therefore, in order to avoid carbon formation, it desirable to operate the stack at high flush gas space velocities, provided this is not prohibitively expensive.

### Example 6

CP is estimated for a set of realistic operating conditions: The inlet temperature is fixed at T=700° C., the space velocity of the flush gas is fixed at SV_{flush}=9 s⁻¹, the molar fraction of CO in the fuel gas was x_{CO}=0.05, and the electrolysis current density was fixed at i=−0.5 A/cm². The effect of varying the space velocity of the fuel gas (SV_{fuel}) was investigated and is plotted in FIG. 4c. Under the chosen set of operating conditions, CP=134.9 at 1 s⁻¹, CP=0.8 at 7 s⁻¹, and CP=−43.8 at 13 s⁻¹. Generally, the higher the space velocity of the fuel gas, the lower the CP. Therefore, in order to avoid carbon formation, it desirable to operate the stack at high fuel gas space velocities, provided this is not prohibitively expensive.

### Example 7

CP is estimated for a set of realistic operating conditions: The inlet temperature is fixed at T=700° C., the space velocity of the flush gas is fixed at SV_{flush}=9 s⁻¹, the space velocity of the flush gas is fixed at SV_{flush}=9 s⁻¹, and the electrolysis current density was fixed at i=−0.5 A/cm². The effect of varying the molar fraction of CO in the fuel gas (x_{CO}) was investigated and is plotted in FIG. 4d. Under the chosen set of operating conditions, CP=−24.6 at x_{CO}=0.01, CP=0.8 at x_{CO}=0.05, and CP=2.6 at x_{CO}=0.10. Generally, the higher the molar fraction of CO in the fuel gas, the higher the CP. Therefore, in order to avoid carbon formation, it desirable to operate the stack at low CO molar fractions, provided Ni in the fuel-side inlets of the stack remains in metallic state.

### Example 8

CP is estimated for a set of realistic operating conditions: The inlet temperature is fixed at T=700° C., the space velocity of the flush gas is fixed at SV_{flush}=9 s⁻¹, the space velocity of the flush gas is fixed at SV_{flush}=9 s⁻¹, and the molar fraction of CO in the fuel gas was x_{CO}=0.05. The effect of varying the electrolysis current density (i) was investigated and is plotted in FIG. 4e. Under the chosen set of operating conditions, CP=−69.8 at −0.1 A/cm², CP=0.8 at −0.5 A/cm², and CP=81.8 at −1.5 A/cm². Generally, the more negative the electrolysis current density, the higher the CP. Therefore, in order to avoid carbon formation, it desirable to operate the stack at low electrolysis current densities (i.e. at currents close to zero). However, the production rate of the stack is directly proportional to the absolute value of the electrolysis current, and therefore high current densities (i.e. more negative currents) are required to ensure commercial relevance.

### Example 9

An SOEC stack consisting of 75 cells is operated at an average temperature of 700° C. with pure CO₂ fed to the cathode at a flow rate of 100 Nl/min, while applying an electrolysis current of 50 A and providing a conversion of CO₂ into CO corresponding to 26% CO and 74% CO₂ in the gas exiting the cathode side of the stack. This corresponds to the disclosure in Example 1 of WO 2018/206235.

The above example describes an operating point of an SOEC stack in dry CO₂ electrolysis. The operating temperature (T) is 700° C. and the molar fraction of CO in the fuel gas stream (x_{CO}) is 0. However, D1 does not disclose geometric information about the stack in order to make the estimation of SV_{fuel}, SV_{flush} and i possible. For example, although a value for the volumetric flow rate of the fuel gas is provided (100 Nl/min), it is necessary to know the total volume of the fuel-side compartment (V_{fuel}) in order to estimate the value for SV_{fuel} Similarly, although a value for the stack current is provided (50 A), it is necessary to know the active area per cell (and whether the cells are connected in series or parallel) in order to estimate the value for i. Finally, no mention of the flush gas flow rate or space velocity, nor whether a flush gas is used at all, is mentioned in Example 1 of WO 2018/206235.

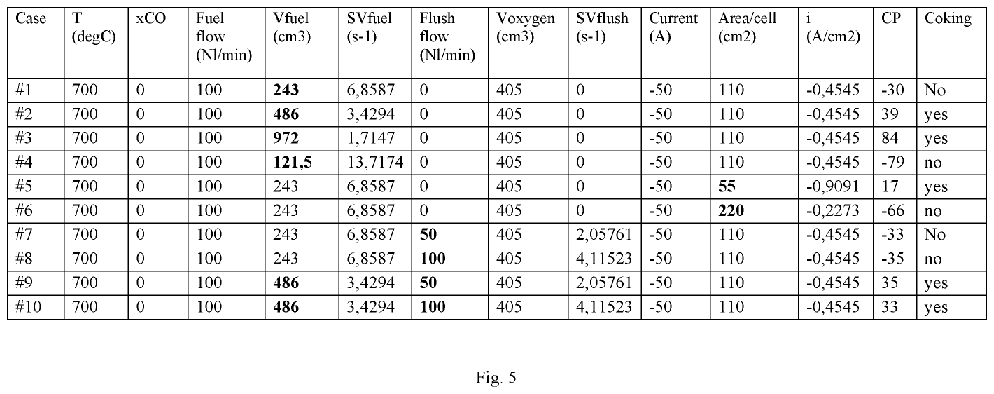

In FIG. 5, coking potentials have thus been calculated for a number of possible SV_{fuel}, SV_{flush} and i combinations, based on assumptions regarding V_{fuel}, V_{oxygen} and cell active area.

In Case #1, V fuel V_{oxygen} and cell active area (A) values have been taken from Example 1 of the current application. For the avoidance of doubt it should be emphasized that these do not represent a preferred embodiment nor are the SV, cell areas mentioned in Example 1 of WO 2018/206235).

Cases #2-#4 represent variations in V_{fuel}, which result in changes in SV_{fuel}. By increasing SV_{fuel}, coking can be avoided. At low SV_{fuel}, coking occurs.

Cases #5-#6 represent variations in cell active area compared to #1. By increasing cell active area, coking can be avoided. By decreasing cell active area, coking will occur.

Cases #7-#8 represent variations in flush gas flow rate. Increasing flush gas flow rate has a small positive effect, making coking slightly less likely.

Cases #9-#10 represent variations in flush gas flow rate at a higher SV_{fuel}. Increasing flush gas flow rate has a small positive effect, making coking slightly less likely. However, coking still occurs.

In summary these data clearly show that not enough information is disclosed in Example 1 of WO 2018/206235 to accidentally anticipate the subject-matter of the present patent application. Nor are there any hints or suggestions in that direction.

### EMBODIMENTS

Embodiment 1. A method for converting carbon dioxide into carbon monoxide in high-temperature, dry, solid oxide electrolysis, the method comprising the following steps:
1) providing a fuel gas stream comprising 70-100 vol % CO₂ and 0-30 vol % CO, wherein the molar fraction of CO (x_{CO}) is in the range of from 0 to 0.3;
2) providing a flush gas stream;
3) providing a solid oxide electrolysis cell stack (SOEC stack) comprising a plurality of solid oxide electrolysis cells (SOECs), each cell having a fuel side and an oxy side in ionic contact through a solid electrolyte, and the plurality of SOECs being electrically connected in series and fluidly connected in parallel and separated by interconnectors;
4) heating the fuel gas stream to a fuel gas inlet temperature, T, in the range of from 600-1000° C., such as from 700° C. to 850° C.;
5) supplying the fuel gas stream to the fuel sides of the SOECs at a space velocity, SV_{fuel} r in the range of from 1-30 s⁻¹;
6) supplying the flush gas stream to the oxy sides of the SOECs at a space velocity, SV_{flush} in the range of from 0.1-20 s⁻¹;
7) applying an electrolysis current with a current density, i, in the range of from −0.2 A/cm² to −1 A/cm² across the solid electrolyte to electrolytically convert a fraction of the CO₂ into CO on the fuel side of the electrode side and to produce an O₂ enriched flush gas on the oxy electrode side of the SOECs.

Claims 2-14 may equally be combined with Embodiment 1.

Embodiment 2. A method for converting carbon dioxide into carbon monoxide in high-temperature, dry, solid oxide electrolysis, the method comprising the following steps:
1) providing a fuel gas stream comprising 70-100 vol % CO₂ and 0-30 vol % CO, wherein the molar fraction of CO (x_{co}) is in the range of from 0 to 0.3;
2) providing a flush gas stream;
3) providing a plurality of solid oxide electrolysis cell stacks (SOEC stacks) comprising a plurality of solid oxide electrolysis cells (SOECs), each cell having a fuel side and an oxy side in ionic contact through a solid electrolyte, and the plurality of SOECs being arranged in SOEC stacks, the SOECs being electrically connected in series and fluidly connected in parallel and separated by interconnects; and each stack being mounted on a manifold for simultaneously feeding the fuel gas stream to each stack and for simultaneously receiving the product gas stream from each stack;
4) heating the fuel gas stream to a fuel gas inlet temperature, T, in the range of from 600-1000° C., such as from 700° C. to 850° C.;
5) supplying the fuel gas stream to the fuel side of the SOECs at a space velocity, SV_{fuel} r in the range of from 1-30 s⁻¹;
6) supplying the flush gas stream to the oxy side of the SOECs at a space velocity, SV_{flush} in the range of from 0.1-20 s⁻¹;
7) applying an electrolysis current with a current density, i, in the range of from −0.2 A/cm² to −1 A/cm² across the solid electrolyte to electrolytically convert a fraction of the CO₂ into CO on the fuel side of the electrode side and to produce an O₂ enriched flush gas on the oxy electrode side of the SOECs.

Claims 2-14 may equally be combined with Embodiment 2.

### REFERENCE SIGNS LIST

1: SOEC
2: SOEC
10: SOEC
11: fuel side
12: oxygen-ion conducting electrolyte
13: oxy side
20: power supply unit
30: gas purification unit
40: interconnect
101: fuel gas/fuel gas stream
102: product gas stream
103: electrolyte
104: flush gas/flush gas stream
105: oxygen enriched flush gas stream
201: gas stream
202: CO enriched product gas stream
203: CO2 enriched gas stream

1. A method for converting carbon dioxide into carbon monoxide in high-temperature, dry, solid oxide electrolysis, the method comprising the following steps:
1) providing a fuel gas stream comprising 70-100 vol % CO₂ and 0-30 vol % CO, wherein the molar fraction of CO (x_{CO}) is in the range of from 0 to 0.3;
2) providing a flush gas stream;
3) providing a solid oxide electrolysis cell (SOEC) having a fuel side and an oxy side;
4) heating the fuel gas stream and the flush gas stream to a gas stream inlet temperature, T, in the range of from 600 to 1000° C., such as from 700° C. to 850° C.;
5) supplying the fuel gas stream to the fuel side of the SOEC at a space velocity, SV_{fuel}, in the range of from 2 to 30 s⁻¹;
6) supplying the flush gas stream to the oxy side of the SOEC at a space velocity, SV_{flush}, in the range of from 0.1 to 20 s⁻¹;
7) applying an electrolysis current with a current density, i, in the range of from −0.2 A/cm² to −1 A/cm² across the solid electrolyte to electrolytically convert a fraction of the CO₂ into CO on the fuel side of the SOEC and to produce an O₂ enriched flush gas on the oxy side of the SOEC;
wherein x_{CO}, T, SV_{fuel}, SV_{flush}, and i are selected such that the coking potential CP≤−15, where CP is given by the formula (I):
CP=−351.3+1.3828*T+10.249*SV_{flush}−15.570*SV_{fuel}+845*x_{CO}+103.67*i−0.001210*T²+1.2418*SV_{fuel}²−6677*x_{CO}²−68.38*i²−0.017976*T*SV_{flush}−0.017279*T*SV_{fuel}+0.1987*T*x_{CO}−0.54114*T*i+0.04299*SV_{flush}*SV_{flush}*SV_{fuel}+0.884*SV_{flush}*x_{CO}−2.4723*SV_{flush}*i+10.11*SV_{fuel}*x_{CO}+11.021*SV_{fuel}*i+51.0*x_{CO}*i.

2. (canceled)

3. The method according to claim 1, wherein the coking potential CP of formula (I) during operation of the SOEC, is in the range of from −100 to −15, such as −80 to −15 or −60 to −15.

4. The method according to claim 1, wherein the product gas stream comprises in the range of from 15-95 vol % CO.

5. The method according to claim 1, wherein the fuel gas stream consists of 80-100 vol % CO₂, 0-20 vol % CO, 0-1 vol % H₂O and 0-1 vol % H₂, the remainder being inert, wherein the molar fraction of CO (x_{CO}) is in the range of from 0 to 0.2.

6. The method according to claim 1, wherein the fuel gas stream consists of 88-98 vol % CO₂, 1-12 vol % CO, 0-1 vol % H₂O and 0-1 vol % H₂, the remainder being inert, wherein the molar fraction of CO (x_{CO}) is in the range of from 0 to 0.2.

7. The method according to claim 1, wherein the flush gas comprises air, dry air, O₂, CO₂, N₂, steam or a mixture thereof.

8. The method according to claim 1, wherein the solid oxide electrolysis cell comprises a fuel gas inlet to the fuel side of the SOEC and a fuel product gas outlet from the fuel side of the SOEC.

9. The method according to claim 1, wherein the solid oxide electrolysis cell comprises a flush gas inlet to the oxy side of the SOEC and a flush gas outlet from the oxy side of the SOEC.

10. The method according to claim 1, wherein an oxygen enriched flush gas stream is collected from the oxy-side of the SOEC.

11. The method according to claim 1, wherein a CO enriched product gas stream is collected from the fuel side of the SOEC.

12. The method according to claim 11, comprising a further step of dividing the product gas stream into a first, CO enriched gas stream and a second, CO₂ enriched gas stream.

13. The method according to claim 12, wherein the second, CO₂ enriched stream is recycled to the fuel side of the SOEC.

14. The method according to claim 1, wherein the fuel side of the SOEC comprises metallic nickel which is electrically connected to a power supply.

15. A method for selecting the operating conditions for high-temperature, dry CO₂ electrolysis in a solid oxide electrolysis cell (SOEC) having a fuel side and an oxy side in ionic contact through a solid electrolyte, the method comprising the steps of:
i. supplying a fuel gas stream at a space velocity, SV_{fuel}, in the range of from 2 to 30 s⁻¹, where the fuel gas stream comprises 70-100 vol % CO₂ and 0-30 vol % CO, wherein the molar fraction of CO (x_{CO}) is in the range of from 0 to 0.3 to the fuel side of the SOEC;
ii. supplying a flush gas stream at a space velocity, SV_{flush}, to the oxy side of the SOEC in the range of from 0.1 to 20 s⁻¹
iii. supplying heat to the SOEC by heating the fuel and flush gas streams to a gas stream inlet temperature T, in the range of from 600 to 1000° C. and then
iv. applying an electrolysis current i across the electrolyte of the SOEC at a current density in the range of from −0.2 A/cm² to −1 A/cm²,
wherein the values for T, SV_{fuel}, SV_{flush}, and i are selected by an iterative process as follows:
a) setting the operating conditions for T, SV_{fuel}, SV_{flush}, and i to initial values;
b) determining local temperatures and local gas compositions for a number of diversely distributed locations in the cell;
c) on the basis of the local gas compositions, estimating the local temperatures below which carbon formation via the Boudouard reaction is thermodynamically favorable (the local Boudouard temperature) for each of the locations,
d) subtracting the local Boudouard temperature from the measured local temperature thereby obtaining the Boudouard margin, and
e) varying the gas flow rates, inlet temperature(s) and/or electrolysis current density until the Boudouard margin is larger than zero for each of the locations.
